(19) United States
(12) Patent Application Publication
(10) Pub. No.: US 2019/0211465 A1
(43) Pub. Date: Jul. 11, 2019

(54) Inorganic Fiber Reinforced Gas Separator for Electrochemical Conversion Processes

(71) Applicant: Siemens Aktiengesellschaft, Muenchen (DE)

(72) Inventors: Martin Kalmar Hansen, Vanløse (DK); Kasper Tipsmark Therkildsen, Lille-Skensved (DK)

(73) Assignee: Siemens Aktiengesellschaft, Muenchen (DE)

(21) Appl. No.: 16/311,924

(22) PCT Filed: Jun. 27, 2016
(86) PCT No.: PCT/EP2016/064828

§ 371 Date: Dec. 20, 2018

(51) Int. Cl. C25B 13/08; C25B 1/10; B29C 41/00

(52) U.S. Cl. CPC C25B 13/08; B29K 2309/02; B29C 41/003; C25B 1/10

(57) ABSTRACT

Various embodiments may include a method for making a gas separator for use in electrochemical conversion processes comprising: mixing an inorganic fiber into a solution to form a casting suspension, wherein the solution comprises an organic binding material as a solute and a solvent for the solute; spreading the casting suspension on an inert surface to form a sheet; and extracting the solvent from the sheet to form the gas separator.

### CROSS-REFERENCE TO RELATED APPLICATIONS

This application is a U.S. National Stage Application of International Application No. PCT/EP2016/064828 filed Jun. 27, 2016, which designates the United States of America, the contents of which are hereby incorporated by reference in their entirety.

### TECHNICAL FIELD

The present disclosure relates to gas separators for electrochemical conversion processes. Various embodiments may include an inorganic fiber reinforced gas separator for use in electrochemical conversion processes.

### BACKGROUND

Electrochemical conversion processes such as electrolysis are used for various purposes, for example in Hydrogen and/or Oxygen generation achieved by hydrogen evolution reaction (HER) and Oxygen evolution reaction (OER) in an electrolyser by electrolysis of electrolytes e.g. water. Usually, alkaline or acidic water is used as the electrolyte. The electrochemical conversion devices in which such electrochemical conversion processes are performed, for example electrolyser, include electrodes that conduct electrical energy to the electrolyte and thus decomposes the electrolyte and/or other added reactants to generate desired products such as oxygen gas, hydrogen gas, etc. An important component used in such electrochemical conversion processes is a gas-tight membrane or a diaphragm that divides the electrochemical conversion devices into chambers or compartments and allows flow of ions from one such chamber to another but does not allow flow of gases such as Oxygen or Hydrogen from one chamber to another and thereby keeping the products of the electrochemical conversions separate and thus recoverable. The gas-tight membranes or diaphragms are also referred to as gas separators.

Various types of gas separators are used in electrolysers and various techniques are used to fabricate such gas separators. In a commonly used technique, a solution is made from an organic binding agent in a solvent. Furthermore, an amount of metal oxide and/or metal hydroxide may be added to the suspension. The suspension is then set in form of a sheet and finally the solvent is removed by means of extraction through immersion in a non-solvent. Such gas separators have low mechanical strength and are prone to failure when subjected to pressurized chambers common in the electrolysers in which such gas separators are installed for usage. Furthermore, since such gas separators are fragile, installation of such gas separators into the electrolyser requires high skill and is often complicated and prone to tear or breakage of the gas separators.

To solve the problem of low mechanical strength and durability, often a mesh-structure or a fabric forms the core or substrate of the gas separator. The mesh-structure or the fabric is immersed in or is coated with the suspension and then the mesh-structure or the fabric along with the suspension coating is set to form the gas separator. Subsequently, the solvent is removed by means of extraction through immersion of the gas separator in a non-solvent. Such gas separators with mesh-structure or fabric core or substrate are mechanically stronger but suffer from other disadvantages. One such disadvantage is that dimensions of such gas separators are limited by dimensions of the mesh-structure or fabric used.

Furthermore, setting of the mess-structure or fabric in the suspension is complicated and needs to be carried out with utmost precession to obtain a uniformly formed gas separator. Often the amount of coating of the solution on opposing sides of the mesh-structure or fabric is different and thus results in a non-uniform gas separator which is not optimally efficient for usage in the electrochemical conversion processes. Also, the mesh-structure or the fabric adds to the cost of such gas separators.

### SUMMARY

Some embodiments of the teachings herein may include a gas separator for use in electrochemical conversion processes that is mechanically strong and does not suffer from limitations contributed by the mesh-structure or the fabric. For example, some embodiments may include a method (100) for making a gas separator for use in electrochemical conversion processes, the method (100) comprising: preparing (10) a casting suspension by mixing an inorganic fiber into a solution, wherein the solution comprises an organic binging material as a solute and a solvent for the solute; forming (20) a sheet by spreading the casting suspension on an inert surface; and extracting (30) the solvent from the sheet wherein the solvent is removed to form the gas separator.

In some embodiments, the inorganic fiber is hydrophilic.

In some embodiments, the inorganic fiber is Potassium titanate.

In some embodiments, the inorganic fiber is one of zirconia fibers, Barium sulphate fibers, Wollastonite fibers, and a combination thereof.

In some embodiments, the organic binding material is an organic polymer.

In some embodiments, the organic polymer is one of polysulphone, polyvinylidene fluoride, polyacrylonitrile, polyethyleneoxide, polymethylmethacrylate, or copolymers thereof.

In some embodiments, the solvent is one of N-methyl-2-pyrrolidone (NMP), N-ethyl-2-pyrrolidone (NEP), N,N-dimethylformamide (DMF), formamide, dimethylsulphoxide (DMSO), N,N-dimethylacetamide (DMAC), acetonitrile and mixtures thereof.

In some embodiments, in forming (20) the sheet a layer of the casting suspension with a constant thickness is spread on the inert surface.

In some embodiments, the solvent extraction (30) is performed by evaporating (32) the solvent from the sheet.

In some embodiments, the solvent extraction (30) is performed by leaching (34) the solvent out of the sheet wherein the solvent is leached out of the sheet by immersing the sheet into and/or washing the sheet using a non-solvent.

In some embodiments, the non-solvent is one of water, an alcohol, and a combination thereof.

In some embodiments, in preparing (10) the casting suspension a metal oxide and/or a metal hydroxide is added (12) to the solution.

In some embodiments, in preparing (10) the casting suspension, a pore forming material is added (14) to the solution and wherein the method (100) further comprises removing (40) the pore forming material from the sheet simultaneous with and/or subsequent to the extracting (30) the solvent from the sheet.

In some embodiments, the pore forming material is a polymer.

As another example, some embodiments may include a gas separator for use in electrochemical conversion processes wherein the gas separator is formed by the method (100) according to the description above.

### BRIEF DESCRIPTION OF THE DRAWINGS

The present disclosure is further elaborated hereinafter with reference to illustrated embodiments shown in the accompanying drawing, in which:

FIG. 1 depicts a flow chart showing an embodiment of a method incorporating teachings of the present disclosure; and

FIG. 2 depicts a flow chart showing another embodiment of the method incorporating teachings of the present disclosure.

### DETAILED DESCRIPTION

Some embodiments include a method for making a gas separator for electrochemical conversion processes. In some embodiments, a casting suspension is prepared by mixing an inorganic fiber into a solution. The solution has an organic binding material as a solute, and a solvent. Thereafter, a sheet is formed by spreading the casting suspension on an inert surface such as glass surface. Finally, the solvent is extracted from the sheet wherein the solvent is removed to form the gas separator. Due to presence of the inorganic fibers the requirement of having a mesh like structure to form the core of the separator is obviated and thus dimensions of the gas separator of the present technique are not limited by the mesh-structure or the fabric. Furthermore, the inorganic fibers provide mechanical strength to the gas separator.

In some embodiments, the inorganic fiber is hydrophilic. One such example is Potassium titanate. Other inorganic fibers such as zirconia fibers, Barium sulphate fibers, Wollastonite fibers, and a combination thereof may also be used. Thus, the inorganic fibers also function as the hydrophilic part of the gas separator hence ensuring the ionic conductivity for the gas separator.

In some embodiments, the organic binding material is an organic polymer such as polysulphone, polyvinylidene fluoride, polyacrylonitrile, polyethyleneoxide, polymethylmethacrylate, or copolymers thereof. The polymers have high heat resistance, oxidation/reduction resistance, and durability and sheet forming properties.

In some embodiments, the solvent is one of N-methyl-2-pyrrolidone (NMP), N-ethyl-2-pyrrolidone (NEP), N,N-dimethylformamide (DMF), formamide, dimethylsulphoxide (DMSO), N,N-dimethylacetamide (DMAC), acetonitrile and mixtures thereof. These provide examples for realizing the method of the present technique by providing a solvent for the solute i.e. the organic binding material.

In some embodiments, in forming the sheet a layer of the casting suspension with a constant thickness is spread on the inert surface. Thus the gas separator so formed has constant thickness thus ensuring uniform properties at different parts of the gas separator.

In some embodiments, the solvent extraction is performed by evaporating the solvent from the sheet. In some embodiments, the solvent extraction is performed by leaching the solvent out of the sheet wherein the solvent is leached out of the sheet by immersing the sheet into and/or washing the sheet using a non-solvent such as water, an alcohol, and a combination thereof. In some embodiments, only one of the solvent extraction by evaporation and the solvent extraction by leaching may be performed or alternatively the solvent extraction by evaporation and the solvent extraction by leaching may both be performed one after the other in any order. This provides simple and effective techniques for solvent extraction.

In some embodiments, in preparing the casting suspension a metal oxide and/or a metal hydroxide is added to the solution. Examples of metal oxide may be, but not limited to, Zirconium dioxide, titanium oxide, and so on and so forth. Thus ensuring an increase in hydrophilic component of the gas separator and thereby enhanced ionic conductivity for the gas separator.

In some embodiments, in preparing the casting suspension, a pore forming material is added to the solution. Furthermore, the method includes removal of pore forming material from the sheet simultaneous with and/or subsequent to the extracting the solvent from the sheet. The pore forming material may be, but not limited to, Zinc oxide, a polymer such as polyvinylpyrrolidone (PVP). Thus the overall porosity of the gas separator is modified as required for the use of the gas separator.

Some embodiments include a gas separator for electrochemical conversion processes. The gas separator is formed by the method according to the above mentioned aspect of the present technique. The gas separator of the present technique does not require a mesh-structure or a fabric as the core or substrate of the gas separator. Thus, the gas separator of the present technique is not limited by the dimensions of the mesh-structure or the fabric, and is mechanical strong, durable, economical and functional to be used in various electrochemical conversion processes such as alkaline water electrolysis.

Hereinafter, above-mentioned and other features of the present technique are described in detail. Various embodiments are described with reference to the drawing, wherein like reference numerals are used to refer to like elements throughout. In the following description, for purpose of explanation, numerous specific details are set forth in order to provide a thorough understanding of one or more embodiments. It may be noted that the illustrated embodiments are intended to explain, and not to limit the teachings herein. It may be evident that such embodiments may be practiced without these specific details.

In some embodiments, inorganic fibers form the gas separator wherein the inorganic fibers provide mechanical strength to the gas separator and thus need of a mesh-structure or fabric core is obviated. Furthermore, the inorganic fibers run through the gas separators and provide enhanced ionic conductivity to the gas separator. In other words, inorganic fibers provide mechanical reinforcement of the gas separator and ionic conductivity.

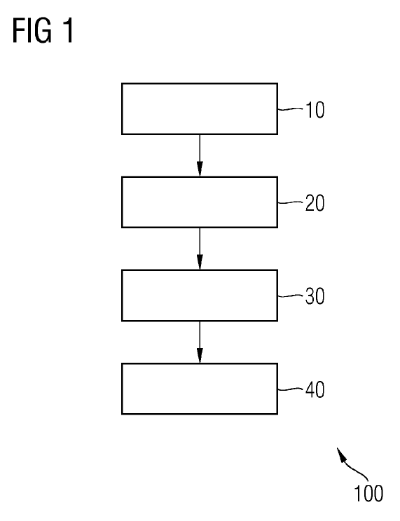

FIG. 1 depicts a flow chart representing an exemplary embodiment of a method 100 incorporating teachings of the present disclosure. The method 100 is for making a gas separator that is for use in electrochemical conversion processes, such as for use in an electrolyser for performing alkaline water electrolysis. The gas separator may be suited for alkaline cells, in particular as a gastight separator or diaphragm, filled with electrolyte, and positioned between the electrodes of the alkaline cells. In the method 100, in a step 10 a casting suspension is prepared by mixing an inorganic fiber into a solution. The solution has an organic binding material as a solute and the solution further has a solvent for the solute.

Examples of the inorganic fibers mixed or added to the solution include, but not limited to, Potassium titanate, zirconia fibers, Barium sulphate fibers, Wollastonite fibers, and a combination thereof. Potassium titanate has been observed to be particularly stable in use of alkaline water electrolysis. In some embodiments, the inorganic fibers are hydrophilic. The amount of the inorganic fibers added to the solution may be selected based on the requirement for which the gas separator is being made. In general, a suitable amount of the inorganic fibers, for example Potassium titanate, is between 5 percent by weight and 85 percent by weight.

To make the casting suspension, the solution of the organic binding material, such as a polymer binding agent for example polysulphone is first prepared in a solvent such as N-methyl-2-pyrrolidone (NMP), for example in a proportion of 10 to 30 percent by weight binding agent in relation to the amount of solvent. Other examples of suitable materials to be used as the organic binging material are, but not limited to, polyvinylidene fluoride (PVDF), polyacrylonitrile (PAN), polyethyleneoxide (PEO), polymethylmethacrylate (PMMA), or copolymers thereof. Other examples of the solvent include, but not limited to, N-ethyl-2-pyrrolidone (NEP), N,N-dimethylformamide (DMF), formamide, dimethylsulphoxide (DMSO), N,N-dimethylacetamide (DMAC), acetonitrile and mixtures thereof. In some embodiments, the inorganic fibers are added and mixed well to evenly distribute the inorganic fibers in the solution.

Subsequently, in the method 100, in a step 20, a sheet is formed, from the casting suspension so prepared in step 10, by spreading the casting suspension on an inert surface such as a glass surface. By means of a pouring device the casting suspension, on a glass surface or any other inert surface, is spread evenly or is spread first and then evened out with a blade or wipe action to form a substantially even layer of the casting suspension on the inert surface, for example a layer of 100 to 1,000 micrometer of the casting suspension is applied onto the glass surface. It may be noted that formation of any bubbles in the sheet are avoided. The casting suspension may be allowed to set on the inert surface by letting the casting suspension to rest on the inert surface for several hours.

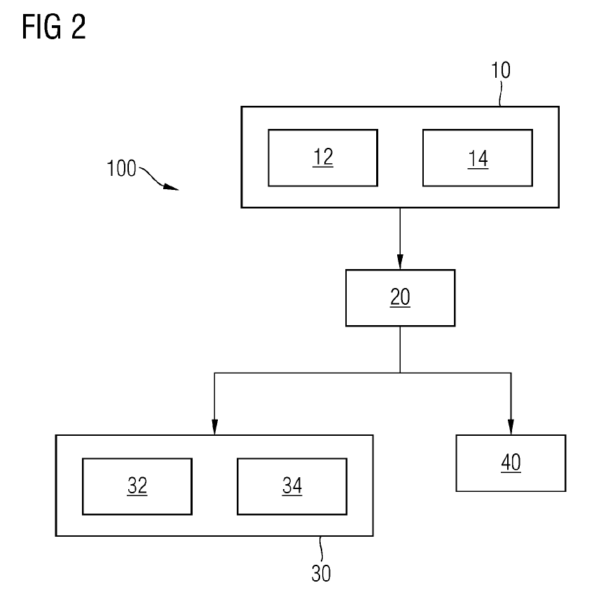

Finally in the method 100, in a step 30 the solvent, for example the NMP, is extracted from the sheet so formed on the inert surface and thus forming the gas separator of the present technique. Extraction of the solvent from the sheet has been explained in further details hereinafter with respect to FIG. 2.

FIG. 2, in combination with FIG. 1, represents a flow chart of various other exemplary embodiments incorporating teachings of the present disclosure. As shown in FIG. 2, in step 30 of the method 100, the extraction of the solvent from the sheet may be performed either by evaporating the solvent from the sheet in step 32 or by leaching the solvent from the sheet as shown in step 34 or by both i.e. first by evaporating 32 the solvent from the sheet followed by leaching 34 the solvent from the sheet or first by leaching 34 the solvent from the sheet followed by evaporating 32 the solvent from the sheet. The step of evaporating the solvent is performed by letting the sheet, either still on the glass surface or removed from the glass surface, to stand for up to several hours. Subjecting the sheet to elevated temperatures increases the rate of evaporating of the solvent from the sheet thereby facilitating the step 32.

In the step 34 of leaching the solvent from the sheet, the solvent is leached out of the sheet by immersing the sheet into and/or washing the sheet using a non-solvent such as water, an alcohol, and a combination thereof. The sheet as set on the inert surface or the sheet removed from the inert surface is immersed in the non-solvent, preferably at room temperature. Suitable types of alcohol are ethanol, but especially isopropyl alcohol. Usually, an immersion time of 20 to 40 minutes is sufficient. The major part of the solvent is extracted in the non-solvent. The remaining solvent is removed by immersing the diaphragm or the gas separator) in a water bath for several hours.

Furthermore, as depicted in FIG. 2, in another exemplary embodiment of the method 100, in the step 10 of forming the casting suspension, a metal oxide and/or a metal hydroxide is added to the solution in a step 12. Examples of metal oxide may be, but not limited to, Zirconium dioxide, titanium oxide, and so on and so forth. The metal oxides/hydroxides so added remain in the sheet and also in the gas separator prepared by the present technique and are not removed from the gas separator. In some embodiments, in step 10 of preparing the casting suspension in a step 14 a pore forming material is added to the solution either along with or subsequent to the addition of the organic binding material and/or the inorganic fibers. The pore forming material may be, but not limited to, Zinc oxide, a polymer such as polyvinylpyrrolidone (PVP), crosslinked polyvinylpyrrolidone (PVPP), poly(vinyl alcohol), poly(vinyl acetate), methyl cellulose and polyethylene oxide.

In some embodiments, at least one pore forming material is added to the casting suspension which advances the pore formation. When using PVP as the pore forming material a suitable amount lies between 0.5 percent by weight and 2 percent by weight, for example 0.7 percent by weight of the entire composition of the casting suspension. Preferably, the pore-forming material is added to the suspension after the organic binding material has been dissolved. In some embodiments, first the pore-forming material is dissolved in the solvent, after which the organic binding material is added to the formed solution, in some cases at an increased temperature, for example at 70 to 75 degrees Celsius.

In some embodiments, the method 100 includes a step 40 of removing the pore forming material from the sheet simultaneous with the step 30 of extracting the solvent from the sheet, as depicted in FIG. 2. In some embodiments, as depicted in FIG. 1, the step 40 of removing the pore forming material from the sheet is performed subsequent to the step 30 of extracting the solvent from the sheet. In some embodiments, the step 40 of removing the pore forming material from the sheet is simultaneous with and continues subsequent to the extracting the solvent from the sheet. The step 40 is performed depending on the pore forming material that was used in the step 14, for example when the pore forming material is Zinc oxide the step 40 is performed by subjecting the sheet to acidic or alkaline bath, whereas when the pore forming material is PVP the step 40 is performed by subjecting the sheet boiling water bath. The pore-forming material provides pores on a surface and internally in the gas separator.

In some embodiments, a gas separator for electrochemical conversion processes is made. The gas separator may be formed by the method 100 according to the above mentioned aspect of the present technique as described in reference to FIGS. 1 and 2. It may be noted that the gas separator of the present technique does not include a mesh-structure or a fabric as the core or substrate of the gas separator.

While the teachings herein have been described in detail with reference to certain embodiments, it should be appreciated that the present technique is not limited to those precise embodiments. Rather, in view of the present disclosure which describes exemplary modes, many modifications and variations would present themselves, to those skilled in the art without departing from the scope and spirit of this invention. The scope of the teachings herein is, therefore, indicated by the following claims rather than by the foregoing description. All changes, modifications, and variations coming within the meaning and range of equivalency of the claims are to be considered within their scope.

What is claimed is:

1. A method for making a gas separator for use in electrochemical conversion processes, the method comprising:
mixing an inorganic fiber into a solution to form a casting suspension, wherein the solution comprises an organic binding material as a solute and a solvent for the solute;
spreading the casting suspension on an inert surface to form a sheet; and
extracting the solvent from the sheet to form the gas separator.

2. The method according to claim 1, wherein the inorganic fiber is hydrophilic.

3. The method according to claim 1, wherein the inorganic fiber comprises Potassium Titanate.

4. The method according to claim 1, wherein the inorganic fiber comprises at least one fiber chosen from the group consisting of: zirconia fibers, Barium sulphate fibers, and Wollastonite fibers.

5. The method according to claim 1, wherein the organic binding material comprises an organic polymer.

6. The method according to claim 1, wherein the organic binding material comprises at least one material chosen from the group consisting of: polysulphone, polyvinylidene fluoride, polyacrylonitrile, polyethyleneoxide, and polymethylmethacrylate.

7. The method according to claim 1, wherein the solvent comprises at least one compound chosen from the group consisting of: N-methyl-2-pyrrolidone (NMP), N-ethyl-2-pyrrolidone (NEP), N,N-dimethylformamide (DMF), formamide, dimethylsulphoxide (DMSO), N,N-dimethylacetamide (DMAC), and acetonitrile.

8. The method according to claim 1, wherein spreading the casting suspension including making a layer with a constant thickness up on the inert surface.

9. The method according to claim 1, wherein extracting the solvent extraction includes evaporating the solvent from the sheet.

10. The method according to claim 1, wherein extracting the solvent extraction includes leaching the solvent out of the sheet by immersing the sheet into and/or washing the sheet using a non-solvent.

11. The method according to claim 10, wherein the non-solvent comprises at least one liquid selected from the group consisting of: water, and an alcohol.

12. The method according to claim 1, wherein preparing the casting suspension includes adding a metal oxide and/or a metal hydroxide to the solution.

13. The method according to claim 1, wherein in preparing the casting suspension includes adding a pore forming material to the solution; and
wherein the method further comprises removing the pore forming material from the sheet simultaneous with and/or subsequent to the extracting the solvent from the sheet.

14. The method according to claim 13, wherein the pore forming material comprises a polymer.

15. A gas separator for use in electrochemical conversion processes, the gas separator comprising:
an inorganic fiber; and
an organic binding material holding the inorganic fiber in a sheet.
